(19) United States
(12) Patent Application Publication
(10) Pub. No.: US 2026/0340546 A1
(43) Pub. Date: Oct. 29, 2026

(54) DEMATERIALISED, AUTONOMOUS AND DECENTRALISED DOCUMENTARY CIRCULATION SYSTEM

(71) Applicant: Pascal Rulfi, Troinex (CH)

(72) Inventor: Pascal Rulfi, Troinex (CH)

(21) Appl. No.: 19/647,075

(22) Filed: Apr. 14, 2026

Related U.S. Application Data
(63) Continuation of application No. PCT/CH2023/050033, filed on Oct. 16, 2023.

(51) Int. Cl. G06Q 10/0633

(52) U.S. Cl. CPC G06Q 10/0633

(57) ABSTRACT

A dematerialized, autonomous, and decentralized system manages and routes business process workflows using self-contained digital containers. Each container encapsulates both routing metadata and payload data, enabling workflow execution without dependency on centralized scheduling systems. The container embeds a complete route descriptor specifying sequential processing steps, actor assignments, task instructions, and tracking information. Processing steps may be arranged in linear sequences or parallel branches with join points. The system operates across heterogeneous computing platforms using standard electronic communication protocols, with each container carrying complete routing intelligence for autonomous, sequential delivery to designated actors. Payload data integrity is ensured through cryptographic hash values and version identifiers. Traceable, interoperable workflow management is achieved through standardized container formats processable by any compatible system, eliminating vendor lock-in and single points of failure.

### CROSS-REFERENCE TO RELATED APPLICATIONS

This application claims priority to International Application No. PCT/CH2023/050033, filled Oct. 16, 2023, published as WO 2025081289, titled “Dematerialised, Autonomous and Decentralised Documentary Circulation System”; the entire contents of that application are incorporated herein by reference.

### TECHNICAL FIELD

The disclosed system relates generally to electronic data transmission and computerized data processing. More particularly, the described method concerns systems and methods for routing dematerialized documents and data between multiple actors according to a predefined process, using an autonomous digital container.

### BACKGROUND OF THE INVENTION

Administrative and business processes have traditionally relied on the physical circulation of paper-based files between participants according to predefined circulation rules. Such manual processes suffer from numerous technical shortcomings, including lack of traceability, risk of loss or omission of documents, absence of real-time process visibility, and limited auditability.

Computerized workflow and process management systems have been developed to address these limitations. However, existing solutions are generally centralized, proprietary, and tightly coupled to specific software platforms or organizational infrastructures. These systems typically rely on centralized workflow engines or schedulers to control process execution, which introduces single point of failure, limits interoperability, and reduces portability across heterogeneous computing environments.

Accordingly, there exists a need for a process-routing system that overcomes these limitations by providing a decentralized, system-independent, and interoperable technical solution capable of autonomous operation without reliance on a centralized control platform.

### SUMMARY OF THE INVENTION

The disclosed system provides a dematerialized, autonomous, and decentralized document routing system based on a digital container.

The digital container embeds, within a single data structure:
(i) routing information defining a predefined process route composed of a plurality of steps and associated actors, and
(ii) payload data useful for executing the process.

All information required for routing, execution, traceability, and progression of the process is stored within the container itself.

As a result, the container is self-sufficient and can be processed by any computer system capable of interpreting the container format, without dependence on a centralized workflow engine, scheduler, or proprietary platform. This architecture provides a concrete technical improvement over prior art workflow systems by eliminating inter-system network transactions required per step transition and by enabling continued autonomous routing upon failure of any external system component.

During execution of a process, the container is routed sequentially, and optionally through parallel branches, between multiple actors using electronic telecommunications means. At each step, an actor processes the container, performs a predefined task, optionally modifies or adds payload data, and forwards the container to a subsequent step based solely on the routing information embedded in the container.

### BRIEF DESCRIPTION OF THE DRAWINGS

FIG. 1 illustrates a simple linear workflow route, showing the sequential progression of the container from initialization through completion.

FIG. 2 illustrates a workflow route including parallel processing paths, showing how a container can be duplicated into multiple branches, processed concurrently, and later merged.

FIG. 3 illustrates a structure of the digital container showing the separation between routing information and payload data.

FIG. 4 illustrates the detailed data structure of the routing information component, showing all metadata fields required for autonomous routing.

FIG. 5 illustrates the detailed data structure of the payload data component, showing document storage, classification, and versioning metadata.

FIG. 6 illustrates the encapsulation of the container within a transport container for transmission via electronic communication means.

FIG. 7 illustrates initialization container data structure used as a template for starting new process instances.

FIG. 8 illustrates the workflow initialization process flowchart showing the steps for starting a new process instance.

FIG. 9 illustrates the container reception process flowchart showing the operations performed when a container arrives at a processing step.

FIG. 10 illustrates the step processing operations flowchart showing the tasks performed by actors at each step.

FIG. 11 illustrates the container forwarding process flowchart showing how the system determines and transmits the container to the next step.

FIG. 12 illustrates payload data versioning in a linear workflow, showing how multiple versions of the same data type accumulate as the container progresses through steps.

FIG. 13 illustrates payload data versioning with branch conflicts, showing how concurrent modifications to the same data type in different branches create version conflicts that require resolution.

FIG. 14 illustrates the data addition operations flowchart showing the process for adding new documents or updating existing ones.

FIG. 15 illustrates the version conflict resolution process flowchart showing manual arbitration of concurrent data versions after branch merging.

FIG. 16 illustrates a specific embodiment where the container is encapsulated in an email message for transmission.

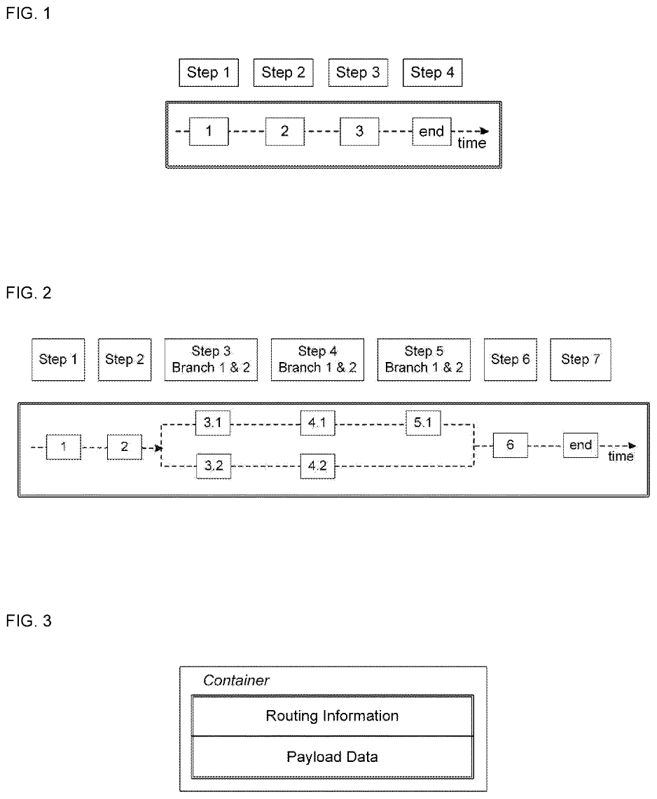

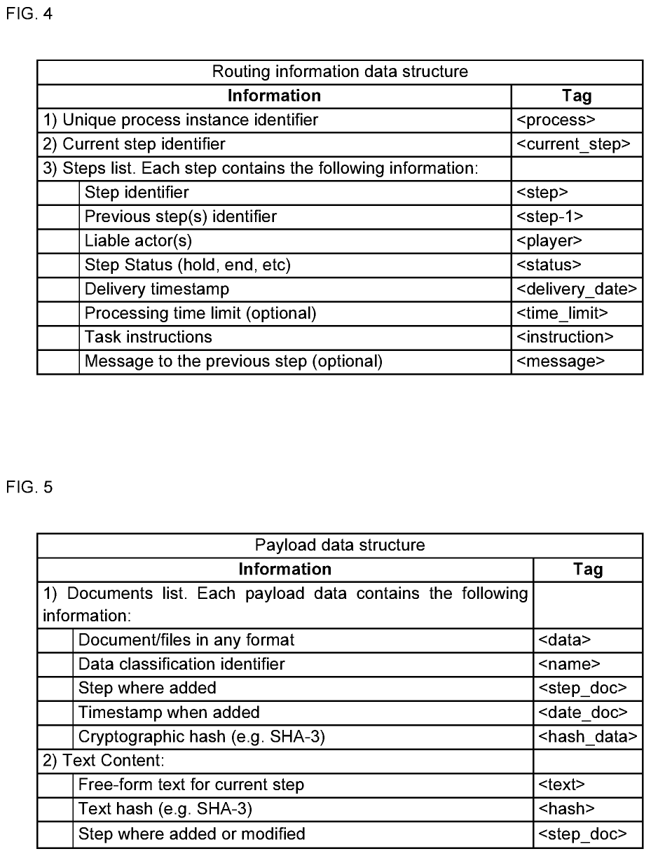

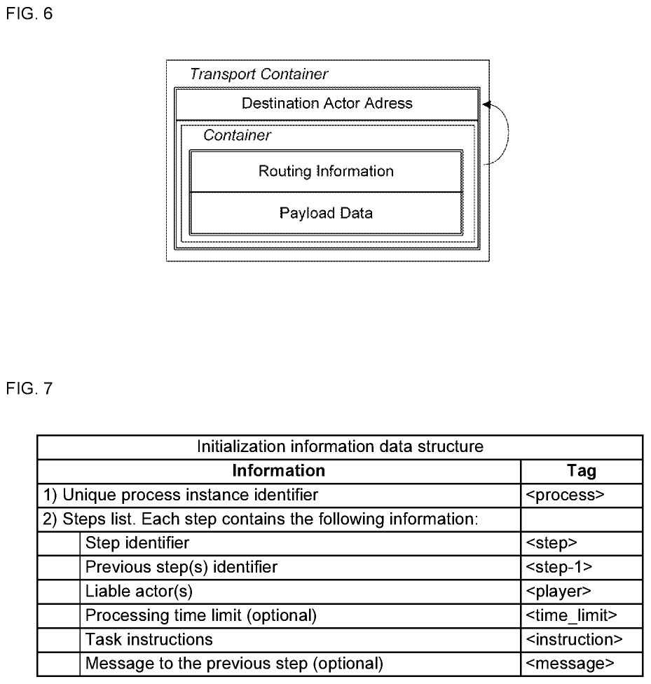

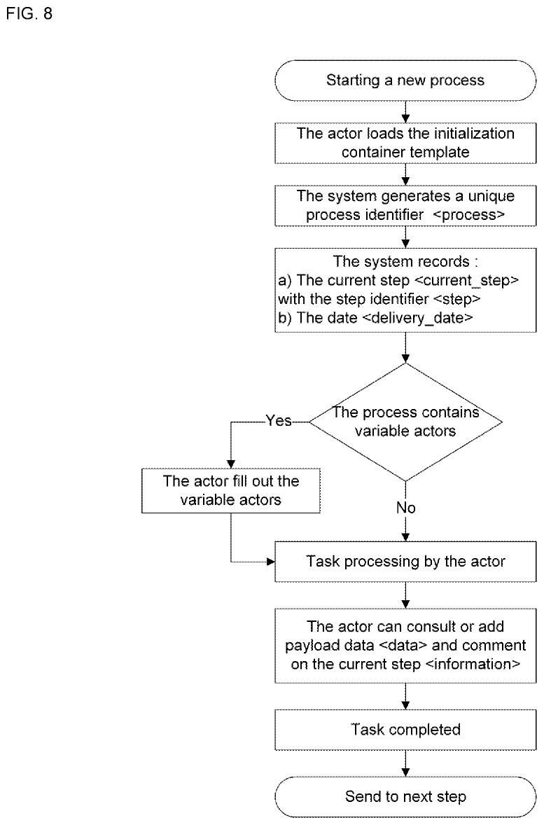

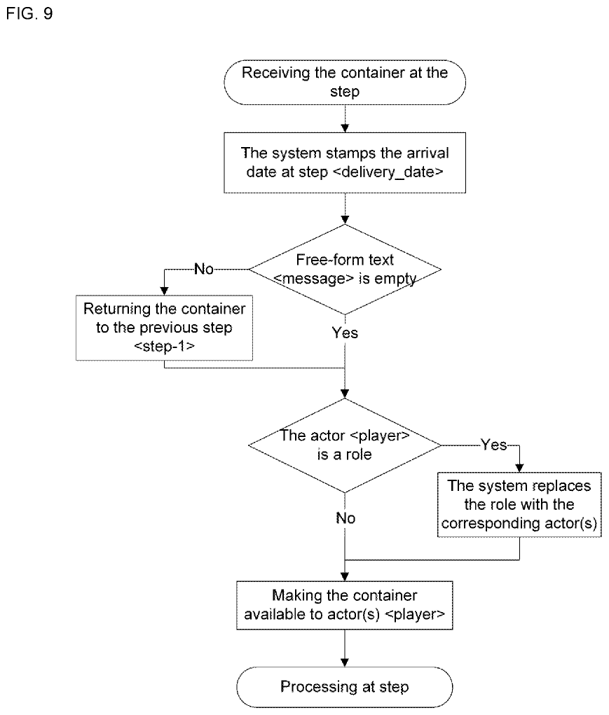

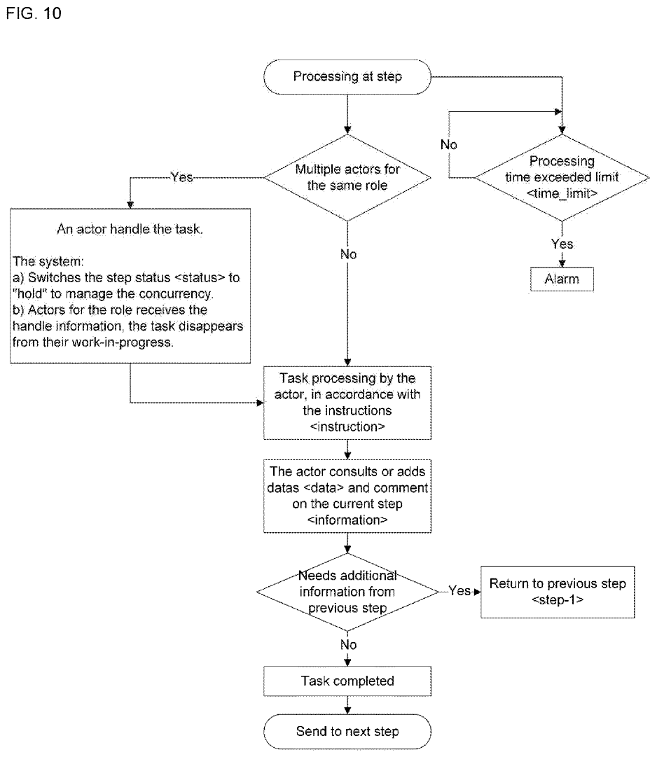

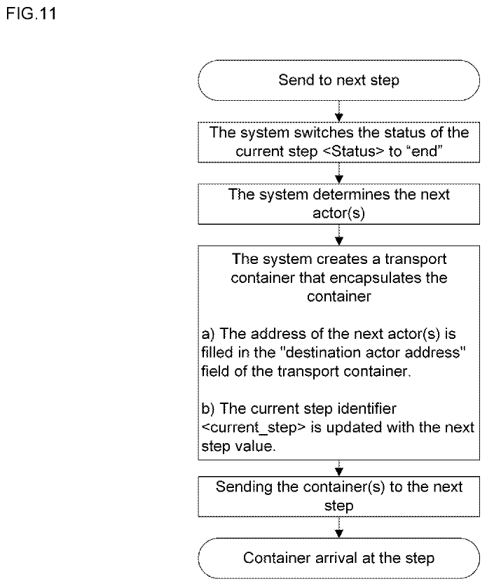

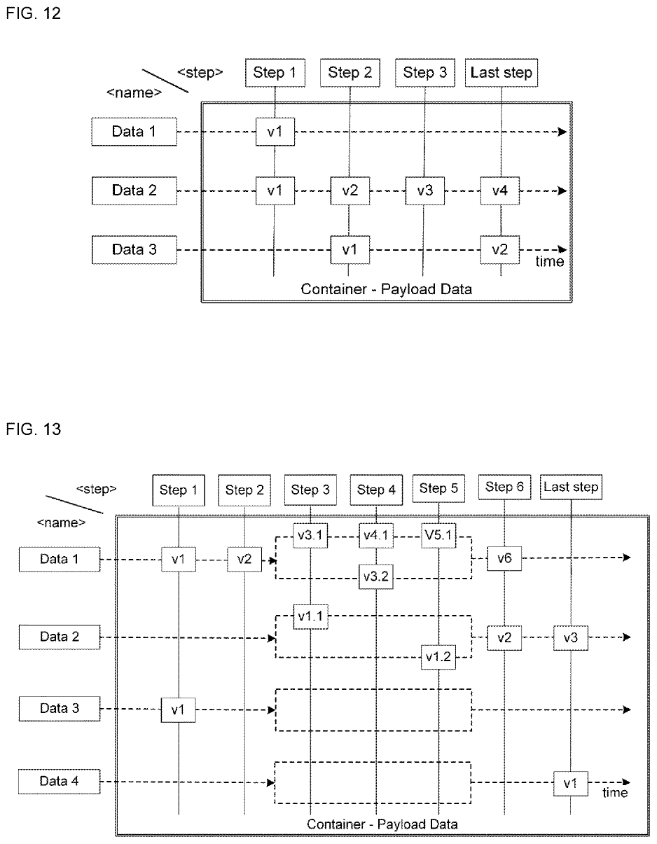

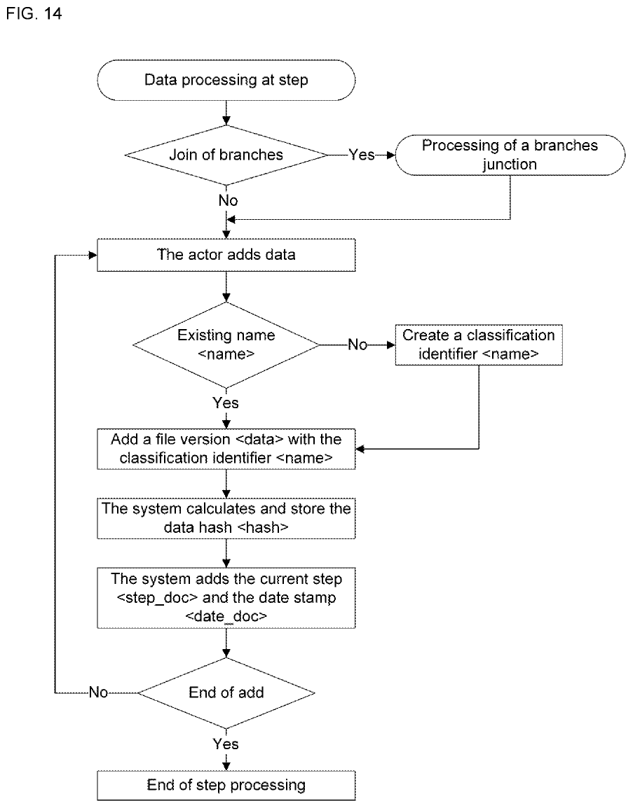

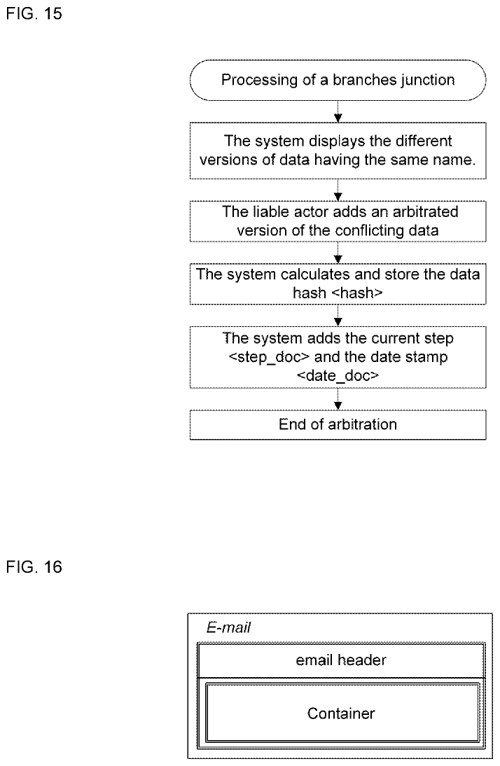

### DETAILED DESCRIPTION OF THE INVENTION

As used herein, the term “sole computational locus of routing state” means that all information necessary to determine the identity and address of the next actor is exclusively stored within the digital container data structure itself. No external system, service, or database is queried, accessed, or required to resolve routing decisions at any step transition. Upon failure or unavailability of any external system component, the container data structure retains complete routing information enabling autonomous resumption of transmission without reconfiguration or external state recovery.

### Overview

A business or administrative process is defined as an ordered set of processing steps, each step being assigned to one or more actors responsible for performing a predefined task. The disclosed system implements such a process through a digital container that autonomously circulates between actors according to a predefined route embedded within the container.

### Actors

An actor is an entity responsible for processing a step of the route. An actor may be a natural person, an organizational role associated with one or more persons, a dynamically assigned variable actor, or an automated machine actor capable of processing the container without human intervention. Each actor is identified by a unique address suitable for electronic transmission.

### Route Definition

The route defines the ordered sequence of steps forming the process. Each step includes a unique step identifier, one or more predecessor step identifiers, one or more associated actors, and optional processing constraints such as time limits, instructions, and status indicators. The route may include linear sequences, branching paths enabling parallel execution, and join points at which conflicting payload versions from parallel branches are deterministically resolved. The complete route definition, including all divergence step records having a plurality of successor step identifiers and all join step records having a plurality of predecessor step identifiers from distinct processing branches, is embedded within the digital container data structure.

### Digital Container Structure

The digital container comprises two principal components:
1. Routing Information, including a unique process identifier, a current step identifier, step definitions, actor assignments, process status indicators, timestamps, and historical execution data.
2. Payload Data, including files of arbitrary format and free-form text used or generated during execution of the process.

All routing and process-control information required to operate the process is embedded within the container, enabling autonomous operation independent of external systems.

### Transport Layer

The digital container is transmitted between actors using electronic telecommunications means. In one embodiment, the container is encapsulated within a transport container such as an electronic message, whose header information specifies the address of the next recipient actor as determined from the routing information embedded in the container.

### Container Processing

At each step, a computer system processes the digital container by extracting routing information, presenting task instructions and payload data to the actor, enabling modification or addition of payload data, updating execution history, and forwarding the container to a subsequent step according to the embedded route definition.

### Payload Data Management

Payload data items are classified using classification identifiers. Multiple versions of a payload data item may coexist within the container. In workflows including parallel branches, concurrent versions of payload data may be generated. A subsequent join step requires arbitration by an assigned actor to deterministically resolve conflicting versions and select an authoritative payload state.

### Distinction From Prior Art

The disclosed system is technically distinguished from prior art workflow systems in the following respects:
Business Process Execution Language (BPEL) and WS-BPML systems require a centralized process engine to evaluate routing decisions; the disclosed system performs all routing decisions exclusively from data embedded within the container itself, without any network request to an external engine.
Blockchain-based smart contract systems require a distributed consensus network for execution; the disclosed system operates over standard electronic communication protocols without dependency on any consensus mechanism or shared ledger infrastructure.
Legacy email-based workflow systems do not embed structured routing logic, integrity verification, or version management within the transmitted artifact; the disclosed system embeds complete routing intelligence, cryptographic hash verification, and structured version management within a single self-contained data structure.
Enterprise service bus and message broker platforms (e.g., Apache Camel,

MuleSoft) are tightly coupled to a centralized integration platform; the disclosed system is transport-protocol agnostic and platform-independent.

The non-obvious combination of: (i) fully self-contained routing intelligence, (ii) cryptographic payload integrity verification, (iii) deterministic parallel-branch version conflict resolution at join points, and (iv) zero dependency on external scheduling services, constitutes a technical advance not disclosed or suggested by the prior art.

### Example Implementation

Example of the digital content (XML) of an initialization container:
<process id=“P-2025-001”>
   <current_step>1</current_step>
      <step id=“1”>
         <step-1>1</step-1>
         <player>variable</player>
         <time_limit></time_limit>
         <instruction>Enter your electronic identity</instruction>
         <message></message>
      </step>
      <step id=“2”>
         <step-1>1</step-1>
         <player>informateur@example. com</player>
         <time_limit>1</time_limit>
         <instruction>Answer the questions</instruction>
         <message></message>
      </step>
      <step id=“3”>
         <step-1>2</step-1>
         <player>ingenieur@example. com</player>
         <time_limit>2</time_limit>
         <instruction>Make a decision</instruction>
         <message></message>
      </step>
         <step id=“4”>
         <step-1>3</step-1>
         <player>press@example. com</player>
         <time_limit>2</time_limit>
         <instruction>Publish the notice</instruction>
         <message></message>
      </step>
   </process>

### Optional Features and Additional Features

Optional features include cryptographic protection of payload data, generation of audit copies for evidentiary purposes, statistical analysis of process execution data, and automated processing by machine actors. In embodiments employing an automated machine actor, the machine actor executes task instructions embedded in the step record without human intervention, processes the container according to the routing information component, and forwards the container autonomously to the next designated actor electronic address.

### Advantages and Technical Effects

The described method provides concrete technical advantages and produces measurable technical effects over prior art workflow and process management systems.

By embedding all routing and process-control information directly within the digital container, the system eliminates the need for a centralized workflow engine or scheduler. This architecture improves system robustness and fault tolerance, as process execution is not disrupted by failure or unavailability of a central control component.

The autonomous nature of the container enables interoperability across heterogeneous computer systems. Because routing logic is format-driven and self-contained, the container may be processed by different hardware platforms, operating systems, and software environments without prior integration or system-specific configuration.

The described method further improves technical traceability and auditability by storing execution history, step identifiers, timestamps, and actor identifiers within the container itself. This allows any processing system to reconstruct the full execution path without reliance on external databases.

Payload data integrity and version control are enhanced through classification identifiers and cryptographic hashes, enabling detection of unauthorized modifications and controlled management of data versions across distributed processing steps.

Support for parallel execution paths and explicit join steps provides a technical mechanism for managing concurrency in distributed workflows. Mandatory arbitration at join points ensures deterministic resolution of conflicting payload data states and prevents inconsistent system behavior.

Finally, use of standard electronic telecommunications mechanisms for transport allows the described method to leverage existing network infrastructure while remaining transport-protocol agnostic, thereby improving scalability, compatibility, and deployment flexibility.

### BEST MODE OF CARRYING OUT THE INVENTION

In a preferred embodiment, the digital container is encapsulated within standard electronic mail messages for transport between actors. Each actor operates container-compatible software, such as an extension to an electronic messaging client, enabling visualization, processing, and routing of the container. Automated computer systems may also process containers without human intervention.

1. A computer-implemented workflow routing system comprising:
one or more processors; and
one or more non-transitory computer-readable media storing instructions that, when executed by the one or more processors, implement a self-contained digital container data structure that functions as the sole computational locus of routing state for a workflow process, the self-contained digital container data structure comprising:
a routing information component stored within the self-contained digital container data structure, the routing information component comprising:
a unique process instance identifier;
a current step identifier designating an active processing step;
a plurality of step records each comprising a step identifier, at least one predecessor step identifier, at least one actor electronic address, and task instructions; and
at least one divergence step record having a plurality of successor step identifiers and at least one join step record having a plurality of predecessor step identifiers from distinct parallel processing branches; and
a payload data component stored within the self-contained digital container data structure, the payload data component comprising one or more data items each associated with a classification identifier and a cryptographic hash value computed from the data item;
wherein the one or more processors are configured to:
determine a next actor electronic address by reading exclusively the routing information component of the self-contained digital container data structure, without issuing any network request to an external scheduling service, orchestration service, or workflow engine; and
transmit the self-contained digital container data structure to the next actor via an electronic communication protocol;
wherein, upon failure or unavailability of any system component external to the self-contained digital container data structure, the self-contained digital container data structure retains all needed routing information to resume autonomous transmission to the next actor without reconfiguration or external state recovery, thereby improving fault tolerance of the distributed computing system by eliminating dependency on external network-reachable components during step transitions.

2. A computer-implemented method for routing a self-contained digital container data structure through a multi-step workflow process, the method comprising:
(a) constructing, in memory, a self-contained digital container data structure comprising:
a routing information component defining a plurality of ordered processing steps, each step associated with a step identifier, at least one predecessor step identifier, at least one actor electronic address, and task instructions; and
a payload data component comprising zero or more data items each associated with a classification identifier;
(b) determining, by reading exclusively the routing information component embedded within the self-contained digital container data structure and without querying any external scheduling service or orchestration service, an electronic address of a first actor designated to process a first step;
(c) transmitting the self-contained digital container data structure to the first actor via an electronic communication protocol;
(d) at each processing step, performing:
(i) reading the routing information component to identify task instructions and the next actor electronic address;
(ii) presenting the task instructions and the payload data component to the designated actor;
(iii) receiving one or more data items from the designated actor;
(iv) computing a cryptographic hash value of each received data item and storing the cryptographic hash value within the self-contained digital container data structure together with the data item, a classification identifier, a step-of-origin identifier, and a timestamp;
(v) recording within the self-contained digital container data structure a delivery timestamp and actor identifier for the current step; and
(vi) transmitting the self-contained digital container data structure to a next actor electronic address read exclusively from the routing information component, without issuing any network request to an external scheduling service or orchestration service;
(e) terminating the workflow process upon reaching a processing step having a terminal status value stored within the routing information component of the self-contained digital container data structure;
wherein steps (b) through (e) reduce the number of inter-system network transactions required per step transition, as compared to systems that query an external workflow engine to determine routing state, by resolving each step transition through exclusive reading of the routing information component embedded within the self-contained digital container data structure, thereby improving processing efficiency and eliminating single-point-of-failure dependencies in the distributed computing system.

3. The system of claim 1, wherein each step record of the routing information component further comprises a step status field configurable to a processing value indicating that the step is actively being executed and a completed value indicating that the step has been finished, and wherein the one or more processors are configured to update the step status field within the self-contained digital container data structure upon each step transition, without writing any routing state to an external database.

4. The system of claim 1, wherein each step record of the routing information component further comprises a processing time limit value specifying a maximum elapsed duration for processing the step, and wherein the one or more processors are configured to generate an alert signal upon detecting that the elapsed time since the delivery timestamp of the current step exceeds the processing time limit value stored within the self-contained digital container data structure.

5. The system of claim 1, wherein each step record of the routing information component further comprises a return message field, and wherein the one or more processors are configured to detect a non-empty return message field upon reception of the self-contained digital container data structure at a processing step and, in response, retransmit the self-contained digital container data structure to the actor electronic address identified by the predecessor step identifier of the current step record, without advancing the current step identifier.

6. The system of claim 1, wherein each data item of the payload data component is further associated with a version identifier, and wherein the one or more processors are configured to maintain within the self-contained digital container data structure a plurality of version identifiers for data items sharing a same classification identifier across successive processing steps, thereby preserving a complete version history of each classified data item without writing version state to any external version control system.

7. The system of claim 1, wherein the payload data component further comprises a free-form text field associated with a step-of-origin identifier, a timestamp, and a cryptographic hash value computed from the text content of the free-form text field, thereby enabling integrity verification of textual annotations stored within the self-contained digital container data structure without requiring access to any external storage system.

8. The system of claim 1, wherein the one or more processors are further configured to reconstruct a complete ordered execution path of the workflow process by reading exclusively a delivery timestamp sequence and actor identifier sequence stored within the self-contained digital container data structure, without accessing any external database, log file, or audit service.

9. The system of claim 1, wherein the one or more processors are further configured to:
upon reaching a divergence step having a plurality of successor step identifiers in the routing information component, create one copy of the self-contained digital container data structure for each successor step identifier, each copy comprising the complete routing information component and payload data component as they exist at the divergence step; and
independently transmit each copy to the actor electronic address designated by the respective successor step identifier read from the routing information component of that copy.

10. The system of claim 9, wherein the one or more processors are further configured to:
upon reaching a join step having a plurality of predecessor step identifiers designating steps from distinct parallel processing branches, identify within the payload data component two or more data items sharing a same classification identifier and originating from different parallel branches;
present the identified data items to a designated arbitration actor; and
receive from the designated arbitration actor a single authoritative version of the data item and store the authoritative version within the self-contained digital container data structure together with a computed cryptographic hash value, a step-of-origin identifier identifying the join step, and a timestamp;
thereby deterministically resolving conflicting payload data states within the self-contained digital container data structure without requiring external coordination or consensus protocols.

11. The system of claim 10, wherein identifying conflicting data items comprises computing a cryptographic hash value of each data item sharing a same classification identifier across the parallel branches and comparing the computed hash values, wherein two data items are identified as conflicting if and only if their respective cryptographic hash values are not identical.

12. The system of claim 1, wherein an actor electronic address stored in a step record of the routing information component identifies one of: a natural person reachable at a specific electronic address; an organizational role resolved at runtime to one or more persons each identified by a respective electronic address; a variable actor whose electronic address is supplied by an initializing actor prior to first transmission and embedded within the routing information component of the self-contained digital container data structure; or an automated machine actor configured to execute the task instructions of a step record and perform the forwarding operation without human intervention.

13. The system of claim 12, wherein, when a step record designates an actor as an organizational role resolvable to a plurality of persons, the one or more processors are configured to set the step status field of the current step record to a hold value upon detection that a first person has accepted the processing task, and to remove the current step from the active task queue of each remaining person associated with the organizational role, wherein preventing concurrent processing of the same step by multiple actors is achieved by the combination of: (i) writing the hold status value exclusively within the self-contained digital container data structure, and (ii) propagating task queue removal notifications derived from said hold status value to remaining persons, without requiring a centralized task lock manager or external coordination service.

14. The system of claim 1, wherein transmitting the self-contained digital container data structure comprises encapsulating the self-contained digital container data structure as content of an electronic mail message, the electronic mail message comprising a header field specifying, as the recipient address, the next actor electronic address read from the routing information component of the self-contained digital container data structure.

15. The system of claim 1, wherein the one or more processors are further configured to verify the integrity of a received data item by computing a cryptographic hash value of the received data item and comparing the computed value against the cryptographic hash value stored within the self-contained digital container data structure for the corresponding data item, and wherein a hash value mismatch causes the one or more processors to generate an integrity violation alert and halt forwarding of the self-contained digital container data structure pending resolution.

16. The system of claim 1, wherein the one or more processors are further configured to generate an audit copy of the self-contained digital container data structure at a designated processing step, the audit copy comprising a snapshot of the complete routing information component and payload data component as they exist at the time of generation, the audit copy being stored separately and rendered immutable after generation by computing and storing a cryptographic hash value of the entire audit copy.

17. The method of claim 2, wherein constructing the self-contained digital container data structure further comprises receiving, from an initializing actor, one or more variable actor assignments each associating a step identifier with an electronic address, and embedding the variable actor assignments within the routing information component of the self-contained digital container data structure prior to step (c).

18. The method of claim 2, wherein step (d)(vi) further comprises, when the routing information component defines a divergence step having a plurality of successor step identifiers, creating a separate copy of the self-contained digital container data structure for each successor step identifier, updating the current step identifier in each copy to the respective successor step identifier, and transmitting each copy to the actor electronic address designated by the respective successor step identifier.

19. The method of claim 2, further comprising detecting, upon reception of the self-contained digital container data structure at a processing step, a non-empty return message field within the routing information component, and in response retransmitting the self-contained digital container data structure to the actor electronic address identified by the predecessor step identifier of the current step record without advancing the current step identifier.

20. One or more non-transitory computer-readable media storing instructions that, when executed by one or more processors, cause the one or more processors to perform the method of claim 2.

21. A distributed workflow routing system comprising a plurality of heterogeneous computing nodes, each computing node comprising one or more processors and one or more non-transitory computer-readable media, wherein each computing node is configured to:
receive a self-contained digital container data structure transmitted via an electronic communication protocol, the self-contained digital container data structure comprising a routing information component and a payload data component, the routing information component constituting the sole computational locus of routing state for the workflow process;
extract, from the routing information component, task instructions and a next actor electronic address without issuing any network request to an external scheduling service, orchestration service, or workflow engine;
present the task instructions and the payload data component to a designated actor associated with the computing node;
update the routing information component within the self-contained digital container data structure to record a delivery timestamp and actor identifier for the current step; and
transmit the self-contained digital container data structure to the next actor electronic address read exclusively from the routing information component;
wherein the plurality of heterogeneous computing nodes operate without a shared workflow engine, without a shared database, and without prior integration configuration, thereby achieving interoperable distributed workflow execution across heterogeneous computing environments.
